(19) United States
(12) Patent Application Publication
(10) Pub. No.: US 2009/0041308 A1
(43) Pub. Date: Feb. 12, 2009

(54) Object execution method and method with bio-characteristic recognition

(75) Inventors: Shih-Hsin Chang, Taipei Hsien (TW); Chan-Ping Po, Taipei Hsien (TW)

Correspondence Address: OLIFF & BERRIDGE, PLC, P.O. BOX 320850, ALEXANDRIA, VA, 22320-4850, US

(73) Assignee: ACER INCORPORATED, TAIPEI HSIEN (TW)

(21) Appl. No.: 12/071,115

(22) Filed: Feb. 15, 2008

(30) Foreign Application Priority Data
Aug. 8, 2007 (TW) 096129289

(51) Int. Cl. G06K 9/00; G06F 17/30

(52) U.S. Cl. 382/117; 382/115; 382/124; 382/118; 707/6; 707/E17.016

(57) ABSTRACT

An object execution system and a method with bio-characteristic recognition are disclosed. The system includes a biometric apparatus, a storage unit and a processing unit. The biometric apparatus is provides for receiving an inputted bio-characteristic data. The storage unit saves at least one predetermined bio-characteristic data, at least one profile and a lookup table of recording the corresponding relationship between the predetermined bio-characteristic data and the profile. The profile records a plurality of objects to be executed. The processing unit inquires the profile corresponding to the inputted bio-characteristic data based on the lookup table, and executes the plurality of objects recorded by the profile.

### FIELD OF THE INVENTION

The present invention generally relates to an object execution system and a method with bio-characteristic recognition, and more particularly to a technical field of utilizing bio-characteristic recognition to execute a plurality of objects.

### BACKGROUND OF THE INVENTION

Recently, bio-characteristic recognition technique matures gradually. Many different bio-characteristics are utilized to identify users such as fingerprint characteristics, face characteristics, iris characteristics or vena characteristics.

For example, the fingerprint recognition technique is to detect fingerprint images of the user firstly, and specific fingerprint characteristics of the fingerprint images then is extracted and saved. Afterward, when the user shows his/her fingerprints again, the fingerprint characteristics is extracted again to compare with the fingerprint characteristics previously saved. If both are matched, the personal identification of the user is exactly confirmed.

Much equipment currently use fingerprint recognition technique to verify the personal identification of the user such as computer login, security/access control, identification verification and data encryption. After the user identifies his/her identification through fingerprint recognition, these equipment and functions can be employed. For instance, the user can set a short message function corresponding to the fingerprint characteristics of his/her thumbs. When the user scans his/her thumbs again, the short message function of an electronic mobile apparatus can be started.

However, under the current computer's operating environment of the user, many programs and files are often executed to improve the working efficiency. The bio-characteristic recognition can only provide personal identification and single program execution.

To overcome the foregoing shortcomings, the inventor(s) of the present invention based on years of experience in the related field to conduct extensive researches and experiments, and finally invented an object execution system and a method with bio-characteristic recognition as a method or a basis for resolving the foregoing drawback.

### SUMMARY OF THE INVENTION

Accordingly, an objective of the present invention is to provide an object execution system and a method with bio-characteristic recognition to improve the convenience.

To achieve the foregoing objective, the object execution system with bio-characteristic recognition includes a biometric apparatus, a storage unit and a processing unit. The biometric apparatus is provided for receiving an inputted bio-characteristic data. The storage unit is provided for saving at least one predetermined bio-characteristic data, at least one profile and a lookup table of recording a corresponding relationship between the predetermined bio-characteristic data and the profile. The profile is provided for recording a plurality of objects. The processing unit is provided for inquiring the profile corresponding to the inputted bio-characteristic data based on the lookup table and executing the objects recorded by the profile.

Moreover, the present invention further provides an object execution method with bio-characteristic recognition that comprises the following steps of:
i) providing a lookup table stored at least one predetermined bio-characteristic data and a profile associated with the predetermined bio-characteristic data;
ii) receiving a bio-characteristic data from a biometric apparatus;
iii) inquiring a profile corresponding to the bio-characteristic data from the lookup table based on the received bio-characteristic data; and
iv) executing a plurality of objects recorded by the profile.

To make it easier for our examiner to understand the object of the invention, its innovative features and performance, a detailed description and technical characteristics of the present invention are described together with the drawings as follows.

### BRIEF DESCRIPTION OF THE DRAWINGS

The subject matter regarded as the invention is particularly pointed out and distinctly claimed in the concluding portion of the specification. The invention, both as to system and method of operation, together with features and advantages thereof may best be understood by reference to the following detailed description with the accompanying drawings in which:

FIG. 1 is a schematic diagram illustrating an object execution system with bio-characteristic recognition of the present invention;

FIG. 2 is a schematic diagram illustrating an object execution system with bio-characteristic recognition according to an embodiment of the present invention;

FIG. 3 is a schematic diagram illustrating a setting interface of the present invention;

FIG. 4 is a flowchart illustrating an object execution method with bio-characteristic recognition of the present invention; and

FIG. 5 is a flowchart illustrating an object execution method with bio-characteristic recognition according to an embodiment of the present invention.

### DETAILED DESCRIPTION OF THE PREFERRED EMBODIMENTS

Referring to the related figures for the object execution system and the method with bio-characteristic recognition according to a preferred embodiment of the present invention, wherein the same elements are described by the same reference numerals.

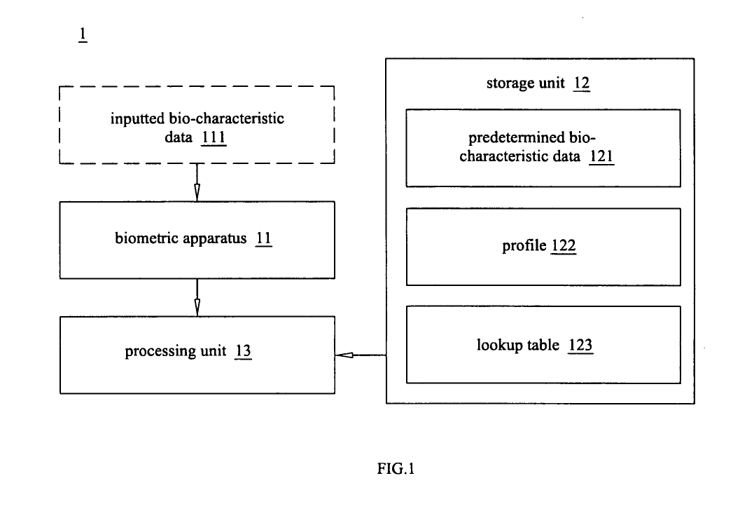

Referring to FIG. 1, the schematic diagram of an object execution system with bio-characteristic recognition of the present invention is illustrated. The object execution system comprises a biometric apparatus 11, a storage unit 12 and a processing unit 13. The biometric apparatus 11 is provided for an inputted bio-characteristic data 111. The storage unit 12 is provided for saving at least one predetermined bio-characteristic data 121, at least one profile 122 and a lookup table 123 of recording the corresponding relationship between the predetermined bio-characteristic data and the profile. The profile 122 is provided for recording a plurality of objects such as an application program and a file. The profile 122 can also record an account and a password of activating the objects upon demands. The foregoing bio-characteristic data is an electrical data selected from the group, including fingerprint data, facial image data, voiceprint data and iris data.

The processing unit 13 is provided for inquiring the profile 122 corresponding to the inputted bio-characteristic data 111 based on the lookup table 123 and executing the objects recorded by the profile. The processing unit 13 also recognizes the inputted bio-characteristic data 111 to confirm whether or not the inputted bio-characteristic data 111 is valid. If the inputted bio-characteristic data 111 is valid, the processing unit 13 then executes subsequent actions.

The object execution system 1 can comprise an interface setting unit (not shown in the figure) for setting the profile and the corresponding bio-characteristic data upon demands. The foregoing setting result can be saved in the lookup table 123. The interface setting unit can provide a setting interface to allow a user to set the bio-characteristic category to be utilized. If the user would like to use the fingerprint to activate the object, the setting interface can allow the user to register his/her fingerprints of thumbs, first fingers, middle fingers, ring fingers or little fingers from the left hand or the right hand. If the user would like to use an audio to activate the object, the setting interface asks the user to produce an audio signal at a predetermined time. If the user would like to use a facial image to activate the object, the setting interface asks the user to face the biometric apparatus 11, such as a face recognition device with a camera, to capture the facial image of the user and to analyze the face data. The interface setting unit is preferably realized by software of utilizing the processing unit to execute a program.

The object execution system 1 also includes a trigger unit, such as a key, for receiving a trigger signal upon demands. The processing unit 13 generates a reminder signal based on the trigger signal, and the reminder signal can be provided for indicating the inputted bio-characteristic data from the biometric apparatus 11. For example, a reminder audio or an image reminder interface is generated to remind the user. In addition, when the hands of the user touch the biometric apparatus 11, the biometric apparatus 11 can generate the trigger signal. The object execution system 1 can also include a display unit for displaying the image reminder interface and the setting interface upon demands. The biometric apparatus 11 is preferably an electrical device selected from the group, including a fingerprint recognition device, an audio recognition device, a face recognition device or an iris recognition device. The key can be a function key of a keyboard or the selection keys of the keyboard or a mouse button. The storage unit 12 is preferably a hard drive or a memory. The processing unit 13 is preferably a microprocessor or microcontroller.

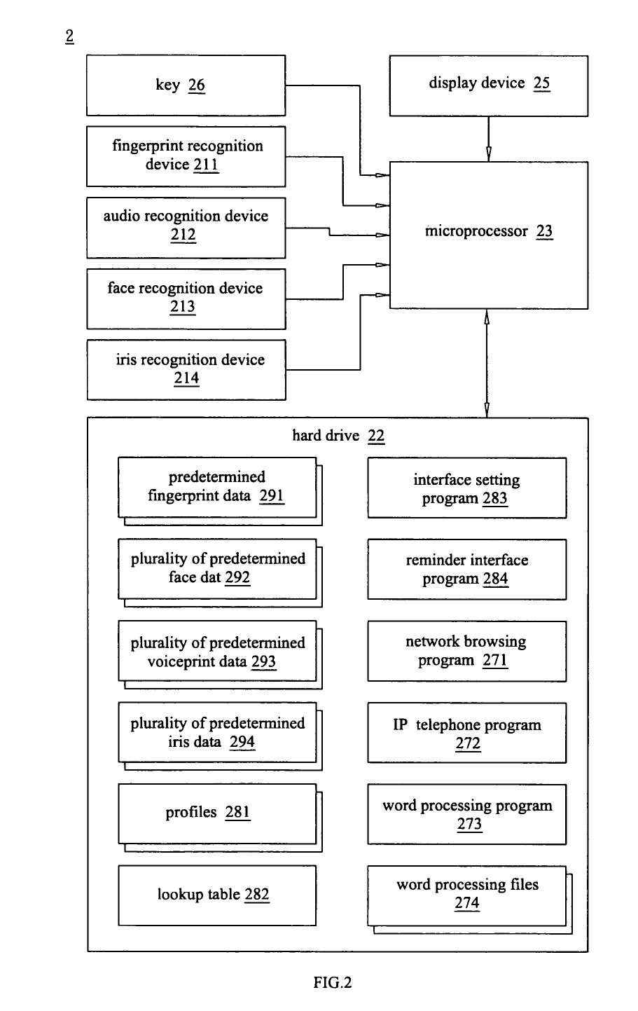

Referring to FIG. 2, the schematic diagram of an object execution system with bio-characteristic recognition according to an embodiment of the present invention is illustrated. The object execution system 2 comprises a fingerprint recognition device 211, an audio recognition device 212, a face recognition device 213, an iris recognition device 214, a hard drive 22, a microprocessor 23, a display device 25 and a key 26. The hard drive 22 is provided for saving a plurality of predetermined fingerprint data 291, a plurality of predetermined face data 292, a plurality of predetermined voiceprint data 293, a plurality of predetermined iris data 294, a network browsing program 271, an IP (internet protocol) telephone program 272, a word processing program 273, a plurality of word processing files 274, a plurality of profiles 281, a lookup table 282, an interface setting program 283 and a reminder interface program 284. Every profile 281 corresponds to at least one bio-characteristic data, and its corresponding relationship is recorded in the lookup table 282. The profile 281 records the plurality of object data to be executed. For instance, the profile 281 can record a plurality of program names, a plurality of file names or at least one program name and at least one file name.

The fingerprint recognition device 211, the audio recognition device 212, the face recognition device 213 and the iris recognition device 214 can respectively receive the fingerprint data, the audio data, the facial image and the iris image inputted by a user. After the user inputs the foregoing data and images, the microprocessor 23 compares the fingerprint data, the audio data, the facial image or the iris image with the predetermined fingerprint data 291, the predetermined face data 292, the predetermined voiceprint data 293 or the predetermined iris data 294 saved in the hard drive 23. If the comparison result is matched, the microprocessor 23 inquires the profile 281 corresponding to the bio-characteristic data from the lookup table 282 based on the received bio-characteristic data, and then executes the programs or files recorded by the profile 281 such as a profile corresponding to a fingerprint of the first finger of the right hand, and records the network browsing program, the word processing program and a word processing file. When the first finger of the right hand of the user touches and slides the fingerprint recognition device 211, the fingerprint recognition device 211 drives the microprocessor to execute the network browsing program and the word processing program sequentially, and opens the word processing file, thereby reducing the operating time and increasing the use convenience. The profile can also record the account and the password of opening the file or activating the program upon demands.

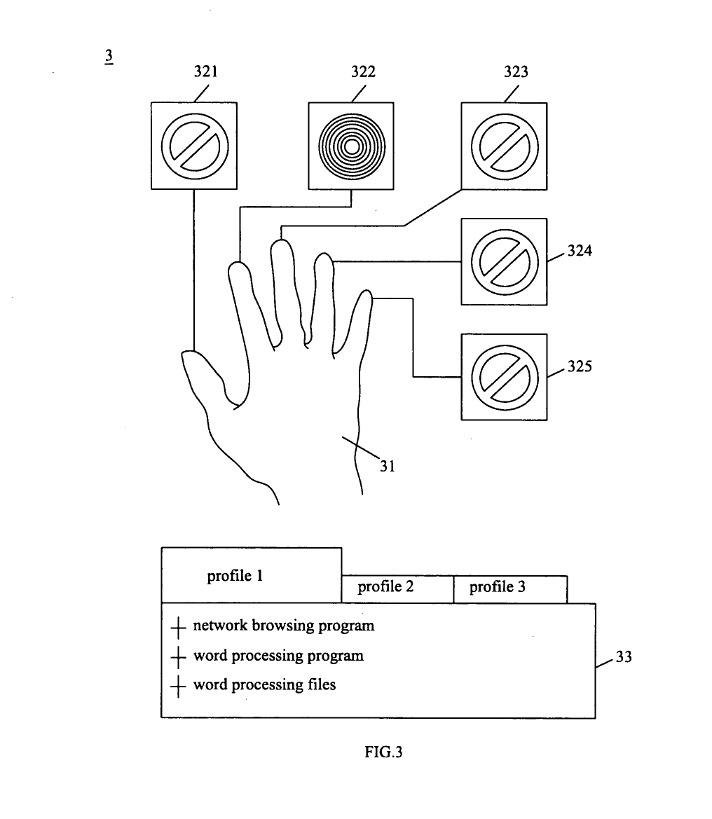

The microprocessor 23 can execute the interface setting program 283 to provide the user to set the profile. As shown in FIG. 3, a schematic diagram illustrates the setting interface according to an embodiment of the present invention. The setting interface 3 takes the setting of the right hand fingerprint as the embodiment. The setting interface 3 displays a right hand 31 and five fingerprint images 321-325 to remind the user to input his/her fingerprints. After the user inputs the fingerprint of the first finger, the fingerprint image 322 would display the inputted fingerprint. The user then edits the profile through the editing interface 33. In the embodiment, the user can drag the program or the file to be executed into the editing interface 33 so as to complete the action of adding the object. After completing the setting, the inputted fingerprint of the first finger of the right hand becomes the fingerprint data 291 saved in the hard drive 22. The setting result is saved in the lookup table, and the setting interface 3 is displayed on the display device 25.

When the key 26 is pressed, a trigger signal is generated and transmitted to the microprocessor 23. After the microprocessor 23 receives the trigger signal, the reminder interface program 284 is executed to display a reminder interface on the display device to remind the user that can input the bio-characteristic program. The key 26 can be a function key of the keyboard or selected keys of the keyboard, mouse buttons or an independent start key. The key 26 is installed for some biometric apparatuses such as the face recognition apparatus 213 or the audio recognition apparatus 212. Since other signal input apparatus are respectively the camera and the microphone, the key 26 must be pressed if the user would like to input the face data or the voiceprint data, so that the microprocessor 23 can process images and audio captured by the camera and the microphone.

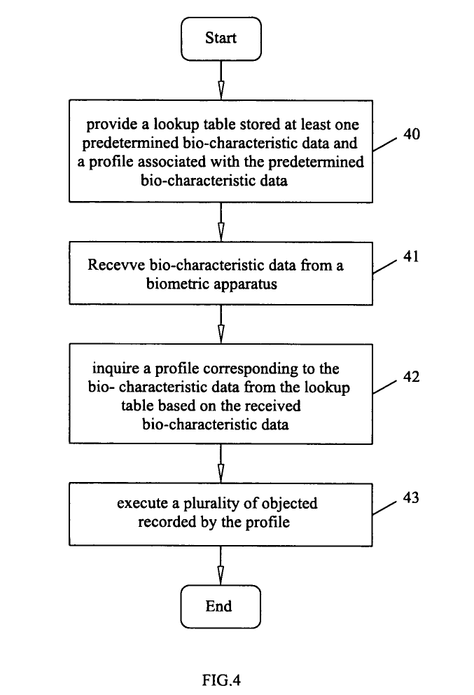

Referring to FIG. 4, for the flowchart of an object execution method with bio-characteristic recognition of the present invention is illustrated. The method comprises the following steps:

Step 40: provide a lookup table stored at least one predetermined bio-characteristic data and a profile associated with the predetermined bio-characteristic data;

Step 41: receive a bio-characteristic data from a biometric apparatus;

Step 42: inquire a profile corresponding to the bio-characteristic data from the lookup table based on the received bio-characteristic data; and

Step 43: execute a plurality of objected recorded by the profile.

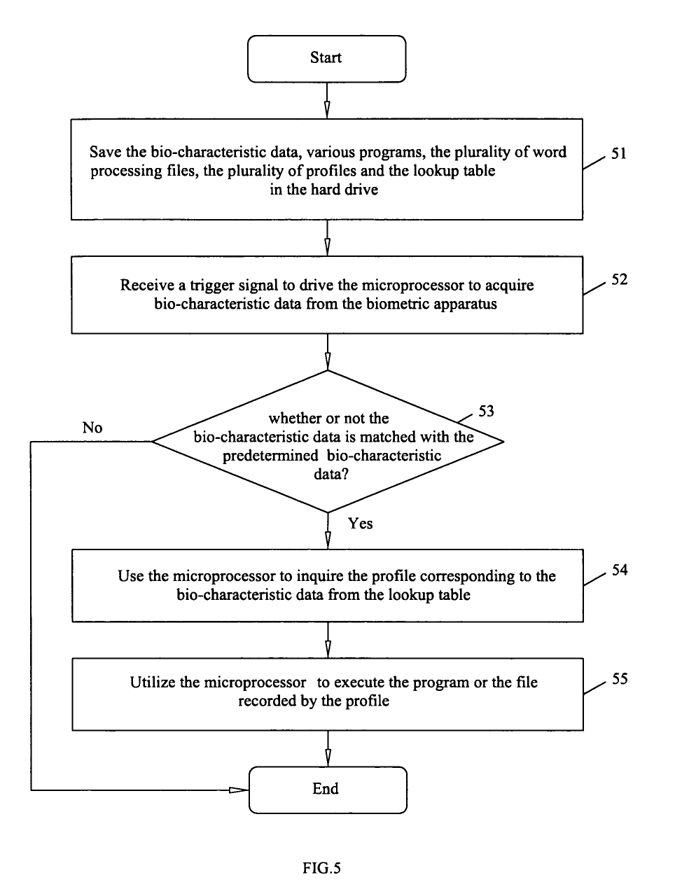

Referring to FIG. 5, the flowchart an object execution method with bio-characteristic recognition according to an embodiment of the present invention is illustrated. The method corresponds to the object execution system 2 as shown in FIG. 2, and comprises the following steps:

Step 51: save the plurality of predetermined fingerprint data 291, the plurality of predetermined face data 292, the plurality of predetermined voiceprint data 293, the plurality of predetermined iris data 294, the network browsing program 271, the IP telephone program 272, the word processing program 273, the plurality of word processing files 274, the plurality of profiles 281, the lookup table 282, the interface setting program 283 and a reminder interface program 284 in the hard drive 22.

Step 52: receive a trigger signal to drive the microprocessor 23 to acquire a bio-characteristic data from the fingerprint recognition device 211, the audio recognition device 212, the face recognition device 213 or the iris recognition device 214. The trigger signal is generated by the key 26 or the fingerprint recognition device 211.

Step 53: determine whether or not the acquired bio-characteristic data is matched with the predetermined fingerprint data 291, the predetermined face data 292, the predetermined voiceprint data 293 or the predetermined iris data 294 saved in the hard drive 22. If the comparison result is matched, step 54 is performed. If the comparison result is not matched, the program is ended and the entire process is finished.

Step 54: use the microprocessor 23 to inquire the profile 281 corresponding to the bio-characteristic data from the lookup table 282 based on the received bio-characteristic data.

Step 55: utilize the microprocessor 23 to execute the program or the file recorded by the profile 281.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An object execution system with bio-characteristic recognition, comprising:
a biometric apparatus for receiving an inputted bio-characteristic data;
a storage unit for saving at least one predetermined bio-characteristic data, at least one profile and a lookup table of recording a corresponding relationship between the predetermined bio-characteristic data and the profile, the profile recording a plurality of objects; and
a processing unit for inquiring the profile corresponding to the inputted bio-characteristic data based on the lookup table, and executing the objects recorded by the profile.

2. The object execution system of claim 1, wherein the object comprises an application program or a file.

3. The object execution system of claim 1, wherein the profile further comprises an account and a password for activating the objects.

4. The object execution system of claim 1, wherein the bio-characteristic data is an electrical data selected from the group comprising fingerprint data, facial image data, voiceprint data or iris data.

5. The object execution system of claim 1, further comprising an interface setting unit for setting the profile and the corresponding bio-characteristic data, wherein the setting result is saved in the lookup table.

6. The object execution system of claim 1, further comprising a trigger unit for receiving a trigger signal, wherein the processing unit generates a reminder signal based on the trigger signal, and the reminder signal indicates the inputted bio-characteristic data of the biometric apparatus.

7. The object execution system of claim 6, wherein the reminder signal includes a reminder audio or an image reminder interface.

8. The object execution system of claim 1, further comprising a display unit for displaying the image reminder interface.

9. The object execution system of claim 6, wherein the trigger unit is a key.

10. The object execution system of claim 1, wherein the biometric apparatus is an electrical device selected from the group comprising a fingerprint recognition device, an audio recognition device, a face recognition device or an iris recognition device.

11. An object execution method with bio-characteristic recognition, comprising the steps of:
providing a lookup table stored at least one predetermined bio-characteristic data and a profile associated with the predetermined bio-characteristic data;
receiving a bio-characteristic data from a biometric apparatus;
inquiring a profile corresponding to the bio-characteristic data from the lookup table based on the received bio-characteristic data; and executing a plurality of objects recorded by the profile.

12. The object execution method of claim 11, wherein the biometric apparatus is an electrical device selected from the group comprising a fingerprint recognition device, an audio recognition device, a face recognition device or an iris recognition device.

13. The object execution method of claim 11, wherein the bio-characteristic data is an electrical data selected from the group comprising fingerprint data, facial image data, voiceprint data or iris data.

14. The object execution method of claim 11, wherein the object is an application program or a file.

15. The object execution method of claim 11, wherein the profile further includes an account and a password for activating the object.

16. The object execution method of claim 11, wherein the step of receiving the bio-characteristic data from the biometric apparatus further comprises the sub-steps of:
receiving a trigger signal; and
generating a reminder signal for indicating the bio-characteristic data inputted to the biometric apparatus based on the trigger signal.

17. The object execution method of claim 16, wherein the reminder signal includes a reminder audio or an image reminder interface.

18. The object execution method of claim 16, wherein the step of receiving the trigger signal further comprises a step of receiving the trigger signal from a key.
